(19) United States
(12) Patent Application Publication
(10) Pub. No.: US 2015/0306827 A1
(43) Pub. Date: Oct. 29, 2015

(54) Apparatus and Method for Surface Rehabilitation

(71) Applicant: Broadtech, Inc., Lewisville, TX (US)

(72) Inventors: David Lopez, Highland Village, TX (US); Henry Keith Moore, Crossroads, TX (US); Spyridon Monastiriotis, Houston, TX (US)

(73) Assignee: Broadtech, Inc., Lewisville, TX (US)

(21) Appl. No.: 14/263,224

(22) Filed: Apr. 28, 2014

(51) Int. Cl. B29D 11/00; G02B 1/14; B29C 73/02

(52) U.S. Cl. CPC B29D 11/00932; B29C 73/02; B29D 11/00865; G02B 1/14

(57) ABSTRACT

A lens refinishing process includes preparing the surface of the lens, determining whether to coat the lens with a polymer coating or polish the lens, either applying a polymer coating to the lens or polishing the lens, and then applying a protective coating. The preparation step includes applying a removal compound to the lens to remove an anti-reflective coating and to create nano-scratches, applying a coupling agent to the exposed substrate, and heating the coupling agent. The polishing step includes iteratively polishing the substrate using different combinations of polishing compound with different grit values together with different types of polishing pads.

### TECHNICAL FIELD

The invention relates generally to the field of rehabilitating the surface of an item and, more particularly, rehabilitating lenses or screens, such as lenses or screens made from glass, plastic, or other materials as may be found on smart phones, tablets, computers, and the like.

### SUMMARY

According to various embodiments, a lens may be refinished by a process including a number of steps.

The lens may be cleaned and prepared. The preparation may include removing all or part of an anti-reflective coating on the lens substrate. During this removal process, nano-scratches may be created in the substrate surface. A coupling agent may be applied to the surface and heated.

A determination may be made, based on the substrate type (e.g., such as glass type or hardness) and the condition of the substrate (e.g., the depth of the scratches), whether to apply a polymer coating to the substrate or polish the substrate. In a coating process, a coupling agent may be applied and heated, a polymer coating may be applied, and a PET film may be applied to the polymer coating. In a polishing process, the substrate may be polished with a polishing compound in sequential steps using polishing compounds with decreasing grit sizes. After either coating or polishing, a protective coating may be applied to the substrate.

In one example embodiment, a lens refinishing process is provided. The process includes preparing the lens and applying a protective coating to the lens. The preparing step may include applying an anti-reflective coating removal compound to a surface of the lens to remove an anti-reflective coating on the lens to expose an underlying substrate, and to create nano-scratches in a surface of the substrate. The preparing step may further include applying a coupling agent to the surface of the substrate, and heating the coupling agent.

### BACKGROUND

Lenses or screens can be found on many different devices such as, for example, computers, televisions, monitors, game consoles, navigation devices, tablets, and mobile telephones, and smart phones. These screens may be scratched, dented, or otherwise marred under normal use. Degradation of the screens causes images, text, and other displayed information to be distorted, unviewable, or unreadable. Prior methods of refinishing screens include rubbing the screen with a polishing compound.

### DETAILED DESCRIPTION

In one example embodiment, a process is provided for rehabilitating glass surfaces. The glass surface may be the surface of a glass lens or screen such as that used as a screen for smart phones, for example. It should be understood that the invention is not limited to any particular devices, however, and has applications for any devices or items that have surfaces that might become marred or scratched. Also, the invention is not limited to any particular material. Although the example embodiment is described in connection with glass, it should be understood that the processes described herein may be applied to plastic, plexiglass, or other materials.

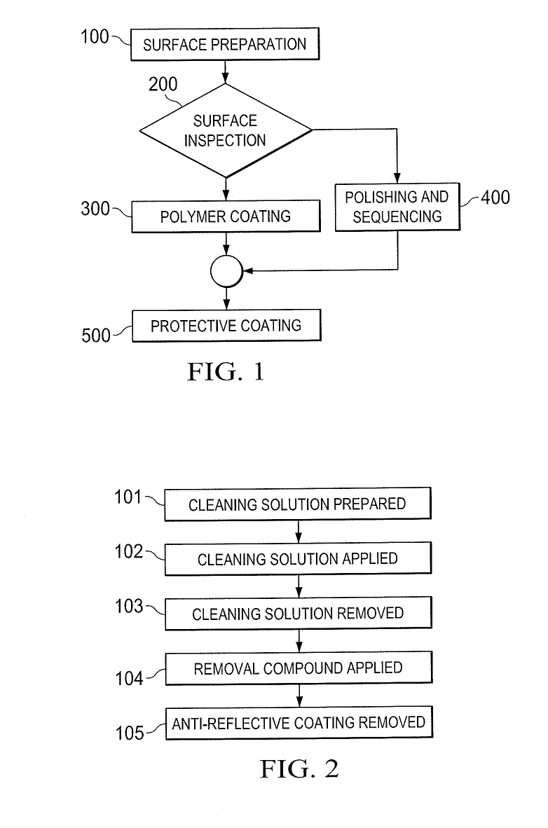

As shown in FIGS. 1-5, in the example procedure, a process for reconditioning a glass screen includes a number of sub-processes. A surface preparation sub-process 100 is employed to prepare the surface for rehabilitation.

As shown in FIG. 2, in a first step 101 of sub-process 100, a cleaning solution comprising isopropyl alcohol is prepared. In a second step 102, the cleaning solution is applied to the surface of the screen to clean off adhesive and dirt residue to make sure the lens surface is clean. Preferably, 3 to 5 drops of the glass-cleaning solution are applied. Even more preferably, one drop of the glass-cleaning solution is applied. Ideally, the entire lens surface is cleaned of all contaminants. In a third step 103 of sub-process 100, the lens is wiped to remove the cleaning solution. Preferably, a clean cloth is used to gently wipe the lens horizontally to remove the cleaning solution, adhesives, and other residue.

In a fourth step 104 of sub-process 100, a light coat of a removal compound is applied to the surface of the lens. The removal compound may comprise any suitable compound capable of removing, for example, an OEM coating on the lens. In a fifth step 105 of sub-process 100, the removal compound is engaged by a polishing device to polish the surface of the lens. The polishing device may be, for example, an orbital buffing tool, such as a 3M™ orbital buffing tool. Preferably, the surface is polished for a period of from about 2 to 4 minutes. Even more preferably, the surface is polished for a period of from 2.5 to 3 minutes (when referring to a 3×5 inch surface area). However, it should be understood that the time frame for coating removal may be varied depending on a number of factors including the type of removal compound, the type of polishing device and the surface area of the lens.

An objective during surface preparation sub-process 100 is twofold. First, this sub-process is aimed at removing the anti-reflective (AR) coating and hydrophobic properties of the OEM coating. Second, the sub-process preferably creates nano-scratches that promote a stronger bond if the surface goes through a coating, or re-coating process. The thickness of an AR coating may be, for example, about a quarter of the wavelength of the incident light (perhaps in the range of 60-100 nm). The coating removal process of the example embodiment incorporates abrasives in the micron scale (1 micron=1000 nm). Preferably, the size of these abrasives is at least 2 orders of magnitude greater than the typical wavelength of incident light. Therefore, after the polishing process, one can be certain that one has removed all of the AR coating and the actual surface substrate has been exposed.

The actual thickness of the removed material is not an issue as long as the AR coating has been sufficiently removed. A sufficient way to actually ensure and characterize the results is to consider a “contact angle measurement.” An AR-coated lens has a high contact angle with distilled water (i.e., a drop of water applied to the surface will bead up). The coating removal process results in low contact angles that indicate a substrate with high surface energy which secures an optimum adhesion potential for coating. Thus, one may verify that the substrate has all of the OEM coating removed by applying drops of distilled water on various places on the surface. If the drop holds its tension and does not “wet out” or spread across the surface, then the coating removal process may be repeated until this effect is achieved. It should be noted that although distilled water is used in this example, other forms of purified water may be used including, for example, deionized water.

In one specific example embodiment of the preparation sub-process, the substrate of an item to be refinished is prepared for either a coating or polishing process. According to this example, the substrate is prepared by a combination of creating nano-scratches, followed by applying a coupling agent, and then heating the substrate. The nano-scratches may be created by applying a removal compound to the surface as previously described. The coupling agent may be a customized coupling agent. For example, the coupling agent may be prepared by mixing about 30 ml isopropyl alcohol and about 30 ml Distilled water in an application bottle. Using a disposable transfer pipette about 2 ml of Gelest Coupling Solution SIM6487.4, which contains the OrganoSilane 3-Methacryloxypropyltrimethoxysilane, may be added. Using another disposable transfer pipette about 1 ml 0.01N Hydrochloric Acid, may be added. The solution is applied evenly across the surface. Using a heat source as previously described, heat is evenly distributed across the surface until the coupling solution is evaporated from the surface. The heating is performed for about 15 to 30 seconds.

Referring again to FIG. 1, in a next step 200 in the refinishing process, the surface is inspected and a visual determination is made as to the depth of the scratches (we are in the process of finding an effect tool to do this step for us). The depth of the scratches may also be determined using any suitable device such as a profilometer or scanning electron microscope. Other characteristics such as cracks or chips in the glass may also be determined. Based on determining the characteristics of the scratches (including depth and any other suitable characteristics), and also based on surface-type, a decision is made whether to proceed to a coating process or to a polishing process. In general, regular glass is a better candidate for the coating process and produces a stronger adhesion of the coating to the surface. Some surfaces such as Gorilla™ glass, for example, are more dense, compressed, or hardened. In general, hardened glass requires a polishing approach. Preferably, if the Mohs hardness is above about 5.5 and/or the Vickers hardness is above about 600, then the polishing approach is used.

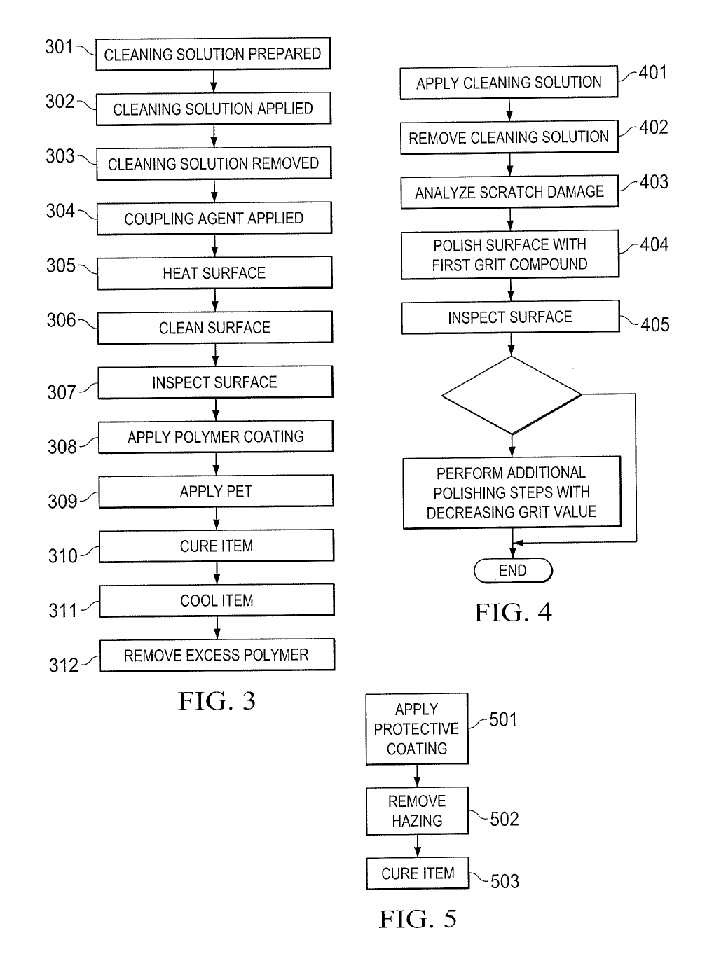

If a coating process is to be performed, then the refinishing process proceeds to a coating sub-process 300, as shown in FIG. 3. In a first step 301 of coating sub-process 300, a cleaning solution is prepared. Preferably, the cleaning solution comprises isopropyl alcohol. In a second step 302, the cleaning solution is applied to the surface of the item. In one example situation, a few drops are applied to the surface and spread evenly over entire substrate area. In a third step 303, a clean cloth is used to remove the cleaning solution. In a fourth step 304, a coupling agent is spread on the surface. Preferably the coupling agent is spread evenly over the entire surface. The coupling agent may comprise a solution as already described above.

In a fifth step 305, heat is applied to the surface where the coupling agent has been applied. Preferably, a direct heat source that generates 80 to 100 degrees Celsius is used. Even more preferably, the direct heat source has little or no ramp time. The heat may be applied quickly. Preferably, the heat is applied for about 15 to 30 seconds. This process is aimed at quickly drying and evaporating the coupling agent on the surface and creating a bond between the glass and a coating, such as a polymer coating for example, which is applied to the glass later in the sub-process. The coupling agent bonds to the glass after being applied and heated. Then the coating bonds to the coupling agent after curing.

In a sixth step 306, the cleaning solution is used to clean the surface. Preferably, the cleaning solution is applied evenly and removed with a clean cloth. In a seventh step 307, the surface is inspected to ensure that it is clean. If not, then the cleaning step may be repeated.

Once the surface is clean, then in an eighth step 308, a polymer coating is applied to the surface. Preferably, this step is performed in a “clean room.” Also preferably, this step is performed within 24 hours of the coupling agent being applied and heated, or the coupling agent may begin to breakdown and lose its coupling effectiveness. The polymer coating is applied evenly to the entire surface. In at least one example, the volume of the polymer coating is directly proportional to the surface area being coated. As an example, a 3 inch by 5 inch area would require 0.2 to 0.25 mL of polymer. The polymer coating is meant to be applied generously on the surface to allow the next step in the process to even out and level the polymer coating on the surface.

In a ninth step 309, a PET (polyethylene terephthalate) film is applied to the top of the polymer coating. Although a PET film is applied in this example embodiment, it should be understood that other films may be alternatively applied. For example, other resins, such as polymer resins, or thermoplastic polymer resins, may be applied. Preferably, the untreated side of the film is applied face down on the polymer. Preferably the film is applied to the entire surface. Once the film is applied, any bubbles are mechanically forced out and any excess polymer of the polymer coating is removed from the sides of the sample. The item is inspected to confirm that all trapped air bubbles are removed, that the PET film is flush with the surface, and that the polymer coating is distributed evenly.

In a tenth step 310, the item is placed in a curing station. Preferably the curing station is an ultra violet (UV) curing station. Using the polymer coating in conjunction with a film, such as a PET film, provides for thorough and complete cross linkage of the coating to the coupling agent within 30 to 45 seconds. The PET film also acts as an insulator to trap the heat which dramatically increases the cure time, as well as protects the surface of the glass from any small debris or contaminates that may fall on the glass during the cure process. In an eleventh step 311, after the item has been cured it is removed from the curing station. The PET film is removed from the surface and the coated glass is allowed to cool. Preferably, the cooling period is on the order of about 24 hours at room temperature. This allows completion of the cross linking and cure process. After has cooled, it is inspected for flash, which is any small excess of cured polymer that hardened over the surface edge. In a twelfth step 312, any excess polymer or flashing is removed. This may be accomplished, for example, by using a belt sander, such as a 3M™ belt sander. After the coating sub-process is complete the item may undergo a protective coating sub-process, which is described below.

In one specific example of the coating sub-process 300, a standard PET film is used to level an applied polymer coating, remove bubbles, and act as a heat insulator to accelerate a UV curing period. In this specific example, the un-treated side of the PET film is applied to the polymer coating. This example process minimizes adhesion issues, keeps dust and particles off the surface while curing, and promotes easy removal of the PET film after the sample is UV cured. A PET film such as Melinex™ may be used, for example, against a customized coating blend. The coating in this specific example is prepared according to the following steps. First, about 30 ml Gelest Zipcone poly (Acryloxypropylmethylsiloxane) silicone solution is mixed in a UV-protected brown bottle. Using a disposable transfer pipette about 1 ml Gelest Coupling Solution SIM6487.4 is added. Using another disposable pipette about from 0 to 1 ml (depending on type of surface being reconditioned) of additive (Gelest SIM 6476.0) 3-Mercaptopropyltrimethoxysilane, is added to help promote cross linking of the coating. The coating is manually leveled by applying pressure to the top side of the PET film using a straight edge followed by a small roller to remove air bubbles and leave a uniform thin coating. Additionally, the film acts as a heat insulator to accelerate the UV curing process. Curing time is from 30 to 40 seconds based on the coating and its additive (Gelest SIM 6476.0) 3-Mercaptopropyltrimethoxysilane). This improves cross-linking of the polymer and extends the life of the UV curing bulb and other equipment. This also minimizes adhesion issues of the film, prevents dust and particles from getting on the surface and into the coating, and promotes easy removal of the PET film after curing.

After the inspection step 200, if it is determined that the item should undergo a polishing process (rather than a coating process), then a polishing sub-process 400 is performed, as shown in FIG. 4. In a first step 401 of polishing sub-process 400, a cleaning solution is applied to the surface of the material being refinished. In one example, a few drops of the cleaning solution is applied and spread evenly over the entire substrate. In a next step 402, the cleaning solution is removed, preferably by using a clean cloth.

In a next step 403, the scratch damage is analyzed and a determination is made as to what grit of a polishing compound is to be used in a polishing process. The deeper the scratches, the more aggressive or abrasive compound is used to level out or open up the scratch. Lighter scratches can be removed with less abrasive compounds.

In a next step 404, a polishing compound with a grit value appropriate for the scratch damage (e.g., based on scratch depth) is selected and the surface is polished. Preferably, the surface is polished using an orbital sander, such as a 3M™ orbital sander. In an example embodiment, the orbital sander is moved across the entire surface applying even pressure. Preferably, the surface is polished for a maximum of seconds to avoid pitting on certain formulations of glass surfaces.

In a next step 405, the surface is inspected for “hazing,” which is a phenomenon that occurs when the glass surface is covered with small to medium micro scratched that make the surface look dull or unclear. The hazing may be removed by a process called “sequencing,” which consists of decreasing the micron (grit) size of the polishing compound until the hazing is gone. The polishing and haze removal steps may be repeated as necessary until the scratch(es) is/are removed.

In one specific example of the polishing sub-process, a predetermined combination of “localized area pressure,” rotational speed of an orbital tool, and travel speed is used to polish the surface and allowing for cooling time increments during sequencing. The pressure, rotational speed, travel speed and cooling times are specific to the lens which is being processed. These parameters change based on the chemical composition and processing of the substrate, such as Sodium Silicate, Potassium Silicate, and Gorilla™ glass 1 2 & 3. In the case of Gorilla™ glass surfaces, it has been determined that too much friction (caused by high rotational speeds, higher applied pressure, and/or slower travel speeds across the glass) can cause a phenomenon called “pitting”. Spaces or pits in the glass surface are thus created during the polishing of the glass. To counteract this problem, cooling times may be introduced into the polishing process (along with properly controlling rotational speed, pressure, and travel speed of the polishing tool. Additionally, the size of the surface impacts the travel speed and cooling times. The process is developed for each lens. A general set of parameters that is acceptable for most glass types is to use a rotational buffer at about 600-900 RPMs with a travel speed of about 20-30 nm per second, and pressure of about 17-22 Newtons.

In a specific example of “sequencing,” polishing is performed iteratively using the correct combination of polishing compound grit value and polishing pads in a specific order. The combination of grit value and polishing pads, as well as the order of polishing steps, depends on the type of substrate being refinished. In this specific example, a sequencing of polishing compounds of various grits in combination with certain types of polishing pads is performed. The polishing pads are Velcro™, Allied High Tech™, Billiard™, Diamat™ and Final Pol™. The combinations, together with other parameters such as polishing pressure, polisher rotational speed, polisher travel speed, and interspersed cooling times are specific to the lens which is being processed. These parameters change based on the chemical composition and processing of the substrate, such as Sodium Silicate, Potassium Silicate, or Gorilla™ glass 1 2 and 3, for example.

The more aggressive or deep the scratch, the higher micron paste is used as the initial polishing agent. For example, with deep scratches about 8-10 microns, a 60 to 45 micron polishing compound may be used. After the initial polishing, progressively finer-grit polishing compounds are used in sequence to repair damage from the previous coarser-grit paste. Higher grit pastes have a better effect in working down the surface and removing deeper scratches. However, the higher grit pastes will cause haze and more overall surface damage. That induced damage is removed by “sequencing” through the polishing process with progressively lower grit polishing compounds.

In one specific example of sequencing, a first polishing step uses a polishing compound with a grit value between 60 and 45 micron combined with either a Velcro™ or Diamat™ polishing pad, which characteristics promote a good impregnation of the compound within the pad for a longer lasting effect on the glass during polishing. A second polishing step uses a polishing compound with a grit value between 20 and 25 micron combined with a Velcro™ or Diamat™ polishing pad. A third polishing step uses a polishing compound with a grit value between 15 and 9 micron combined with a Billiard™ polishing pad, which characteristics are a little smoother and moves across the surface of the glass with less friction to begin repairing scratches as it shines up the glass. Fourth, fifth, and sixth polishing steps use a polishing compound with a grit value of 6, 3, and 1 micron (respectively) combined with a Final Pol™ polishing pad which characteristics are also smooth, but has a very light grip on the glass and used more for creating friction to shin up or promote final polishing up of the glass.

After polishing and/or coating, a protective coating sub-process 500 may be performed, as shown in FIG. 5. This sub-process is preferably performed in a clean room. In a first step 501 of protective coating sub-process 500, a protective coating is dispensed across the surface of the item. Preferably, the entire surface is coated with the protective coating. Preferably, the protective coating is a hydrophobic coating. In a next step 502, the surface is wiped clean to remove hazing. Preferably, the surface is wiped using a clean cloth. This step is preferably performed within 5 minutes of dispensing the protective coating solution on the surface. After removing the hazing, in a next step 503, the item is allowed to cure. The curing step is accomplished at about room temperature under normal lighting conditions. Preferably, curing is done at a temperature of about 71-74 degrees Fahrenheit, with an average humidity of about 35 percent and normal florescent 8 foot clear drop ceiling lighting of 300 to 500 LUX. Preferably, the protective coating is allowed to cure for about 30 to 60 minutes. More preferably, the curing period for the protective coating is about 30 to 40 minutes.

Although the various embodiments have been described above, it should be understood that certain aspects of the embodiments, including certain steps in the various processes and sub-processes may be modified, added, removed, substituted, etc. as is consistent with an understanding in the art. It should be understood that other aspects of the invention and other embodiments will be apparent to those having ordinary skill in the art. Certain other embodiments or variations to embodiments described herein are considered to be a part of the disclosure.

1. A lens refinishing process, comprising:
preparing the lens, wherein preparing comprises:
applying an anti-reflective coating removal compound to a surface of the lens to remove an anti-reflective coating on the lens to expose an underlying substrate, and to create nano-scratches in a surface of the substrate,
applying a coupling agent to the surface of the substrate, and
heating the coupling agent; and
coating the lens with a protective coating.

2. The lens refinishing process of claim 1, wherein the applying step comprises polishing the surface of the lens with the anti-reflective coating removal compound for a time period of about 2 to 4 minutes per 15 square inches of surface area of the surface of the lens.

3. The lens refinishing process of claim 1, wherein the coupling agent comprises about 30 parts isopropyl alcohol, 30 parts distilled water, 2 parts coupling solution containing 3-Methacryloxypropyltrimethoxysilane, and 1 part 0.01N hydrochloric acid.

4. The lens refinishing process of claim 1, wherein heating comprises heating the surface for about 15 to 30 seconds per 15 square inches to evaporate the coupling agent from the surface.

5. The lens refinishing process of claim 1, further comprising, after the preparing step, determining whether to polish or coat the substrate surface based on substrate condition and substrate.

6. The lens refinishing process of claim 5, wherein if the Mohs hardness of the substrate is below about 5.5, a coating process is performed to apply a polymer coating to the substrate.

7. The lens refinishing process of claim 5, wherein if the Mohs hardness of the substrate is above about 5.5, a polishing process is performed to polish the substrate.

8. The lens refinishing process of claim 1, further comprising coating the substrate with a polymer coating.

9. The lens refinishing process of claim 8, wherein coating comprises:
applying a coupling agent to the substrate,
heating the coupling agent, and
applying a polymer coating to the substrate.

10. The lens refinishing process of claim 9, wherein the polymer coating is applied evenly to the substrate at a volume of about 0.2 to 0.25 ml of polymer per 15 square inches of substrate surface area.

11. The lens refinishing process of claim 8, wherein coating comprises:
applying a polymer coating to the substrate; and
applying a polyethylene terephthalate (PET) film to the polymer coating.

12. The lens refinishing process of claim 11, wherein an untreated side of the PET film is applied face-down on the polymer coating.

13. The lens refinishing process of claim 11, further comprising curing the substrate in an ultraviolet curing station.

14. The lens refinishing process of claim 8, wherein the polymer coating comprises about 30 parts Acryloxypropylmethylsiloxane, about 1 part coupling solution, and about 0 to 1 part 3-Mercaptopropyltrimethoxysilane.

15. The lens refinishing process of claim 1, further comprising polishing the substrate with a polishing compound.

16. The lens refinishing process of claim 1, wherein the polishing is accomplished using a rotational buffer at about 600-900 rpms, with a travel speed of about 20-30 nm per second, and at a pressure of about 17-22 Newtons.

16. The lens refinishing process of claim 15, wherein polishing comprises performing a plurality of polishing steps with compounds of decreasing grit value.

17. The lens refinishing process of claim 16, wherein polishing comprises polishing the substrate with a 45 to 60 micron polishing compound using a Velcro™ or Diamat™ polishing pad, and then polishing the substrate with a 20 to 25 micron polishing compound using a Velcro™ or Diamat™ polishing pad.

18. The lens refinishing process of claim 1, further comprising either coating the substrate with a polymer coating or polishing the substrate.

19. The lens refinishing process of claim 1, further comprising applying a protective coating to the substrate.

20. A device having a lens refinished according to the lens refinishing process comprising:
preparing the lens, wherein preparing comprises:
applying an anti-reflective coating removal compound to a surface of the lens to remove an anti-reflective coating on the lens to expose an underlying substrate, and to create nano-scratches in a surface of the substrate,
applying a coupling agent to the surface of the substrate, and
heating the coupling agent; and
coating the lens with a protective coating.
